(19) United States
(12) Patent Application Publication
(10) Pub. No.: US 2026/0045605 A1
(43) Pub. Date: Feb. 12, 2026

(54) PROTECTIVE ELEMENT

(71) Applicant: Carl Freudenberg KG, Weinheim (DE)

(72) Inventors: Richard Zuber, Gorxheimertal (DE); Sven Kochendoerfer, Birkenau (DE); Peter Kritzer, Forst (DE); Robert Scavuzzo, Alexandria, NH (US); Chris Frantz, Saginaw, MI (US); Thomas Kramer, Zotzenbach (DE); Volker Fischer, Gorxheimertal (DE); Manuel Hasieber, Mörlenbach (DE)

(21) Appl. No.: 19/100,629

(22) PCT Filed: Aug. 2, 2023
(86) PCT No.: PCT/EP2023/071360

§ 371 Date: Feb. 3, 2025

(30) Foreign Application Priority Data
Aug. 4, 2022 (DE) 10 2022 119 645.3

(51) Int. Cl. H01M 50/143; H01M 50/129; H01M 50/133

(52) U.S. Cl. CPC H01M 50/143; H01M 50/129; H01M 50/133

(57) ABSTRACT

A protective element, including at least one first layer and at least one second layer. The first layer is made from elastomeric material and the second layer forms a flame-retardant layer. The first layer can include silicone elastomer. The first layer can include a first filler, the first filler being made from inorganic material.

### CROSS REFERENCE TO RELATED APPLICATIONS

This application is a U.S. National Phase application under 35 U.S.C. § 371 of International Application No. PCT/EP2023/071360, filed on Aug. 2, 2023, and claims benefit to German Patent Application No. DE 10 2022 119 645.3, filed on Aug. 4, 2022. The International Application was published in German on Feb. 8, 2024 as WO 2024/028367 A1 under PCT Article 21(2).

### FIELD

The invention relates to a protective element.

### BACKGROUND

A protective element is known from DE 10 2018 113 815 A1. The aforementioned protective element is used in an energy storage system, the energy storage system comprising a housing in which a plurality of storage cells are arranged.

Energy storage systems, especially rechargeable storage devices for electrical energy, are widespread particularly in mobile systems. Rechargeable storage devices for electrical energy are used for example in portable electronic devices such as smartphones or laptops. Rechargeable storage devices for electrical energy are furthermore increasingly used for supplying energy for electrically driven vehicles. A wide range of electrically driven vehicles are conceivable here, for example not just passenger cars but also bicycles, vans and trucks. Applications in robots, ships, aircraft and mobile work machines are also conceivable. Further fields of use of electrical energy storage systems are stationary applications, for example in backup systems, in grid stabilization systems and for storing electrical energy from renewable energy sources.

One energy storage system that is frequently used in this context is a rechargeable storage device in the form of a lithium-ion accumulator. Lithium-ion accumulators (and also other rechargeable electrical energy storage devices) usually have a plurality of storage cells which are installed together in a housing. A plurality of electrically interconnected storage cells are usually combined to form a module.

The energy storage system extends beyond just lithium-ion accumulators. Other rechargeable battery systems, such as lithium-sulfur batteries, solid-state batteries, sodium-ion batteries or metal-air batteries are also conceivable energy storage systems. Supercapacitors are furthermore also possible as energy storage system.

It is only within a limited temperature range that energy storage systems in the form of rechargeable storage devices exhibit the highest electrical capacity and also the best power input and output. Exceeding or falling below the optimal operating temperature range results in a significant drop in the capacity, the power input capability and the power output capability, and impairs the functionality of the energy storage device. Excessively high temperatures may moreover irreversibly damage the energy storage device. Accordingly, sustained elevated temperatures and also short-term temperature spikes should be avoided at all costs. In the case of lithium-ion accumulators, for example, sustained temperatures of more than 50° C. and short-term temperature spikes of more than 80° C. should not be exceeded.

In particular in the case of passenger car applications, a fast-charge capability of the energy storage systems is a requirement. This means that the accumulators forming an energy storage system should be completely or virtually completely charged within a short time, for example within 15 minutes. On account of the efficiency of the charging system of around 90% to 95%, large amounts of heat are released in the energy storage system during the charging operation and must be dissipated from the energy storage system. Such amounts of heat are not released in the normal operating state. Therefore, it is necessary to design the cooling system of the energy storage system so that the heat produced during the charging operation can be absorbed.

Excessively high temperatures can result in irreversible damage to the energy storage system. Known in particular in this context in lithium-ion cells is what is known as thermal runaway. This involves the release of large amounts of thermal energy and gaseous and particulate degradation products within a short time, which results in a high pressure and high temperatures in the housing. The pressure here may be more than 10 bar and temperatures of up to 1000° C. are possible. The particles may have a high temperature and be highly abrasive. In prismatic cells the release occurs in particular in the region of the rupture vents, but in pouch cells the site of release is not defined. This effect is particularly problematic in energy storage systems with a high energy density, as is required for example for the supply of electrical energy in electrically driven vehicles. Increasing amounts of energy in the individual cells and a higher packing density of the cells arranged in the housing entail an intensification of the problem of thermal runaway. Besides thermal runaway, there is also a risk of thermal propagation. Thermal propagation is a cascading propagation of a thermal runaway preferentially to adjacent cells and—due to hot particle jets and arcs—also to remote cells.

### SUMMARY

In an embodiment, the present disclosure provides a protective element, comprising at least one first layer and at least one second layer. The first layer is made from elastomeric material. The second layer forms a flame-retardant layer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a sectional view of a protective element in an embodiment;

FIG. 2 shows a sectional view of an arrangement of the protective element; and

FIG. 3 shows a sectional view of a coated protective element.

### DETAILED DESCRIPTION

In an embodiment, the present disclosure provides a protective element that enables improved operational safety.

Penetration of flames should be prevented or at least a substantial delay of at least 5 minutes should be achieved. Firstly, the housing of the energy storage system should be protected in order to prevent the escape of dangerous particles. Such particles might otherwise enter the passenger compartment in the case of vehicles. Secondly, components to be protected that are adjacent to the housing of the energy storage system, such as further electronic components, should be protected. The protective element should prevent a particle jet emitted from the cell from damaging the component to be protected, or at least delay this for as long as possible

The protective element according to an embodiment of the present disclosure comprises at least one first layer and at least one second layer, wherein the first layer is made from elastomeric material and wherein the second layer forms a flame-retardant layer.

In an embodiment, the thermal conductivity of the first layer is limited by the material properties of the elastomeric material. The elastomeric material is configured such that it preferably has a thermal conductivity coefficient of at most 3 W/(m·K). As a result of the limited thermal conductivity coefficient, the transport of heat through the protective element is reduced and the protective element has thermal insulation properties.

The protective element according to an embodiment of the present disclosure can shield against the hot and possibly particle-laden and abrasive gas, liquid and/or vapor jets in the event of a thermal runaway that has already occurred and also in the event of thermal propagation from the housing wall. The housing and/or module walls arranged therein are often made from deep-drawn sheet steel, aluminum, thermoplastics, thermosetting plastics or composite materials. The protective element prevents the housing or the module walls from, in the event of damage, being damaged to the extent that partial through-melting, crack formation or structural weakening occurs. The protective element further prevents an uncontrolled and premature escape of flames, hot gas/particle jets and therefore also uncontrolled ignition of the carrier and, in the case of electromobility, the setting of the entire vehicle on fire.

The elastomeric material is furthermore preferably partially or completely crosslinked. Crosslinking here is indicative of the extent to which the macromolecular chains of the elastomeric material are crosslinked with one another and form a network. The elastic properties of the material can be influenced by the crosslinking. The crosslinking is preferably effected such that the elastomeric material is elastic. This makes it possible firstly for the protective element to have a desired, often indeed necessary, flexibility for installation and to be able to be installed in a targeted manner and for example bent. This simplifies installation. Moreover, when it is designed to be elastic, the protective element can accommodate changes in the volume of adjacent components.

The elastomeric material is preferably configured such that the protective element exhibits no, or at the most a reduced, tendency to creep. As a result, the protective element has a long service life and can also be used under sustained loading.

Crosslinking systems that can be considered include in particular peroxide vulcanization, platinum-catalyzed addition crosslinking, radiation crosslinking and room temperature vulcanizing systems.

In an advantageous embodiment of the present disclosure, the first layer comprises a silicone elastomer compound. A silicone elastomer compound has a high thermal stability. Resistance of the protective element to high temperatures is achieved as a result. The silicone elastomer compound preferably includes liquid silicone elastomer (LSR) or a high temperature-crosslinking silicone elastomer compound (HTV silicone elastomer compound). In an embodiment of this kind, thermal degradation products in the event of exposure to a flame form a mineral film, or protective layer, which is thermally stable and electrically nonconductive and by way of its protective properties protects the underlying remaining elastomer. This further increases the operational safety of the protective element. The protective element moreover has only a low tendency toward flaking as a result.

The first layer can contain a first filler, wherein the first filler is made from organic material. Organic materials for example include materials such as polyimides, thermosetting plastics, poylacrylonitrile (PAN), oxidized PAN, aramids, cotton or cellulose. These materials have properties of high-temperature stability and improve the stability of the protective element with respect to temperature loading.

The first layer can contain a second filler, wherein the second filler is made from inorganic material. Examples of inorganic fillers of a first group are glass or ceramics, in particular basalt, aluminum oxide, mullite or ZrO₂. Examples of inorganic fillers of a second group are oxides, hydroxides or oxide hydroxides. Also provided are minerals such as mica, silicates, alkaline earth metal carbonates or silicon dioxides. The second filler can in principle be composed of a combination of the abovementioned materials.

The first filler and/or the second filler can contain fillers in the form of fibers. The elastomeric material then forms an elastomer matrix and the fibers are preferably attached to the elastomer matrix by vulcanization. As a result, the advantageous properties of the fiber material can be combined with the advantageous properties of the elastomer matrix. The fibers preferably have a fiber length of between 5 μm and 50 mm and a fiber diameter of between 2 μm and 500 μm.

The first filler and/or the second filler can also additionally comprise further fibers having a fiber length and/or fiber diameter that lie outside of the indicated ranges. Preferably, all of the fibers of the first filler and/or of the second filler have a fiber length and/or a fiber diameter within the indicated range. The fibers are preferably surrounded by the elastomer matrix to an extent of at least 90%, based on the sum total of the surface areas of all fibers. The fibers preferably comprise organic material and/or inorganic material of the first group.

The first filler and/or the second filler can contain fillers in the form of particles. The elastomer material forms an elastomer matrix. The particles are preferably surrounded by the elastomer matrix at least to an extent of 90%, based on the sum total of the surface areas of all particles. The particles preferably have a spherical, platelet-form or amorphous shape. The particles furthermore preferably have endothermic properties. The endothermicity can for example be brought about by a phase transition or by a chemical reaction. The desired temperature range for the endothermicity is between 10° and 800° C. The temperature properties of the protective element can be further improved thereby. The particles preferably comprise inorganic material of the second group.

The first layer can contain an adhesion promoter. In an embodiment, silanes or resins are preferably used as adhesion promoter. This can achieve improved attachment of the first and/or second filler to the elastomer matrix.

The flame-retardant layer can comprise a textile fabric. Textile fabrics that are preferably suitable are woven fabrics and knitted fabrics, where the textile fabric comprises fibers. Also provided are fabrics made from randomly oriented fibers, for example felts or nonwovens. The textile fabric is preferably surrounded by the elastomer matrix at least to an extent of 10%, based on the sum total of the surface areas of the textile fabrics.

The flame-retardant layer can comprise inorganic material. Examples of inorganic materials are glass or ceramic, especially basalt, aluminum oxide, silicate or ZrO₂.

The flame-retardant layer can comprise organic material. Examples of organic materials are polyimides, thermosetting plastics, polyacrylonitrile (PAN), oxidized PAN, aramids, cotton or cellulose. These materials have properties of high-temperature stability.

The flame-retardant layer can furthermore comprise metallic material. The flame-retardant layer preferably comprises metal threads and/or metal fabrics.

The protective element can have a surface structuring. The protective element preferably has surface structurings in the region of the free surfaces. The structuring firstly improves the deformability properties of the protective element and secondly also has a thermal action. Depending on the configuration of the macroscopic structuring, channels can be formed between the protective element and the adjacent component, via which channels the heat emitted by the adjacent component can be dissipated. It is also provided for the structuring to have a thermal insulation effect. It is accordingly provided to form fluid-conducting structures from the surface structuring of the protective element. The fluid-conducting structures also make it possible to discharge gases escaping from a storage cell in the event of thermal runaway.

The protective element can be two-dimensional in form. The two-dimensional protective element can preferably be in the form of sheeting. The protective element furthermore preferably has an elastic deformability such that the protective element, or the preform from which the protective element is produced, can be stored on a reel. This further increases the handleability of the protective element. The protective element preferably has a thickness of 0.3 mm to 5 mm. The protective element preferably has a thickness of 0.8 mm to 2.5 mm. This further increases the deformability of the protective element, so that the protective element has the desired elastic response upon expansion and contraction of adjacent components. The deformability also imparts improved tolerance compensation upon the protective element.

The protective element can be in the form of a shaped part. In an embodiment, the protective element can in particular form a flame-retardant gasket.

The protective element is preferably equipped such that in the event of thermal action, for example in the event of exposure to a flame, it does not generate or release any electrically conductive particles on the side exposed to the flame.

An embodiment of the present disclosure moreover relates to an arrangement, comprising a protective element, a flammable element and an element to be protected from flames, wherein the protective element is arranged between the flammable element and the element to be protected from flames, wherein the flame-retardant layer of the protective element is arranged on the side facing away from the flammable element. It has surprisingly been found that particularly good flame retardancy is achieved when the first layer, which is made from elastomeric material, faces the flammable element, for example a cell rupture vent. It has been found that the flame retardancy is improved in this arrangement, compared to an arrangement in which the second layer forming the flame-retardant layer faces the flammable element. One reason for this is that the elastomeric material of the first layer already exhibits exceptional flame-retardant properties, with the high-temperature-resistant second layer also forming a support layer in the event of heavy thermal loading and ensuring mechanical stability. The element to be protected from flames can be a media-conveying or a current-conveying device.

The arrangement according to an embodiment of the present disclosure additionally has the advantage that the flame-retardant layer comprising the fiber material can be placed between the first layer and the housing. Contaminations by any fibers released can thus be avoided. Contamination of the protective element by the outwardly smooth first layer is additionally impeded.

In the arrangement described, the protective element protects the element to be protected in particular against the penetration of flames coming from the flammable element. The protective element at least ensures a substantial delay. This greatly increases the operational safety.

An embodiment of the present disclosure moreover relates to an energy storage system, comprising a protective element, and also a housing in which at least one storage cell is arranged, wherein the protective element is arranged between the at least one storage cell and the housing, wherein the flame-retardant layer is arranged on the side facing away from the storage cell. An embodiment of this corresponds to the above-described arrangement, wherein the storage cell is a flammable element and the housing is an element to be protected from flames. In particular in the event of thermal runaway or thermal propagation, this arrangement can prevent or delay flames and/or gases from escaping from the housing.

The protective element can be produced by calendering with continuous vulcanization. During calendering, the protective element is guided through the gap between two or more rollers arranged one above the other. Two-dimensional protective elements are preferably produced in this way. It is also provided for injection moulding processes to be used for the production of protective elements as shaped bodies. For specific profile geometries of the protective elements, extrusion is additionally a provided production process. Depending on the production process, the surfaces of the protective elements can have embossments in the form of contours or ribs.

The protective element preferably exhibits an increase in thickness under the action of heat, in particular on exposure to flame, of less than 50%. This distinguishes the protective element of an embodiment of the present disclosure from layers having an intumescent configuration. The temperature protection mechanism of intumescent layers is based on the in situ production, in the event of thermal loading, of a thermally insulating cushion comprising thermal degradation products. However, in the present situation this cushion would disadvantageously hinder the discharge of the gases released from the cell. The risk of blocking important components, such as a venting channel, is also increased as a result. This can in turn firstly lead to an intense rise in pressure in the energy storage system and to the bursting of the energy storage system. Secondly, a buildup of heat can arise in the blocked energy storage system and result in a critically high temperature loading of adjacent components.

The protective element can comprise at least one third layer. Preference is given to providing the third layer, which can be in the form of a coating that is applied to the protective element. In an embodiment, the third layer forms the outer layer of the protective element. The protective element can be provided with the third layer on one side, on multiple sides or on all sides. The third layer can be applied by spray application or blade coating. The third layer preferably comprises a polymeric material, for example silicone elastomer or polyurethane. The third layer can further contain intumescent and/or ceramizing materials that are embedded in the material of the third layer. The third layer further increases the protection of the protective element against thermal and/or mechanical loading.

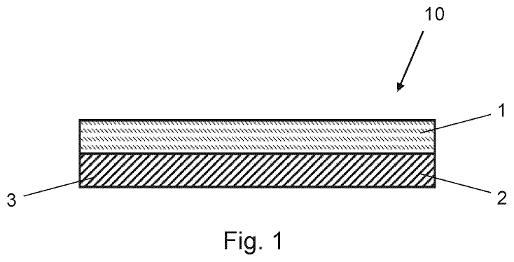

FIG. 1 shows a sectional view of a protective element 10. The protective element 10 comprises a first layer 1 and a second layer 2, wherein the first layer 1 is made from elastomeric material and wherein the second layer 2 forms a flame-retardant layer 3.

The elastomeric material of the first layer 1 in an embodiment has a thermal conductivity coefficient of 1.5 W/(m·K). The elastomeric material in this implementation is additionally partially crosslinked in order to achieve good installation properties by way of elastic properties. The elastomeric material is furthermore elastic in order to accommodate changes in the volume of adjacent components. The elastomeric material also has a reduced tendency to creep, as a result of which the protective element 10 is suitable for sustained loadings.

According to an embodiment, the first layer 1 is made from silicone elastomer. Silicone elastomer has a high thermal stability.

In an embodiment, the first layer 1 comprises a first filler, in this case oxidized polyacrylonitrile. In an embodiment, other organic fillers such as thermosetting plastic, polyacrylonitrile, polyimide, aramid, cotton or cellulose can be used.

In an embodiment, the first filler comprises fibers. The elastomeric material in this case serves as elastomer matrix and the fibers are attached to the elastomer matrix by vulcanization. The fibers are present as a mix of fibers having fiber lengths between 2 μm and 50 mm and fiber diameters between 2 μm and 400 μm. The fibers are largely embedded in the matrix and are surrounded by the elastomer matrix to an extent of 95%.

The first layer 1 comprises a second filler, in this case mica. In an embodiment, other inorganic fillers such as ceramic (in particular basalt, aluminum oxide, mullite, phlogopite, muscovite or ZrO₂), glass or inorganic oxides, hydroxides, or oxide hydroxides, but also minerals, silicates, alkaline earth metal carbonates, borates or silicon dioxides, can also be used.

The second filler is in the form of particles. The particles are mostly embedded in the matrix of the elastomeric material and are surrounded by the elastomer matrix to an extent of at least 95%. The particles have a spherical shape. The particles furthermore have endothermic properties, as a result of which the temperature properties of the protective element 10 are further improved.

In an embodiment, the first layer 1 comprises an adhesion promoter which serves for improved attachment of the first filler and the second filler to the elastomer matrix.

The flame-retardant layer 3 comprises a textile fabric, which in the present case is in the form of a woven fabric. The textile fabric is embedded only partially in the matrix of the elastomeric material and is surrounded by the elastomer matrix only to an extent of 20%.

In an embodiment, the flame-retardant layer 3 comprises organic material, in this case oxidized polyacrylonitrile. In an embodiment, thermosetting plastic, polyacrylonitrile (PAN), polyimide, aramid, cotton or cellulose, but also inorganic material such as ceramic (in particular basalt, aluminum oxide, mullite, phlogopite, muscovite or ZrO₂) or glass, can also be used. Also provided in an embodiment are metallic materials, meaning that the flame-retardant layer 3 can comprise metal threads and/or metal fabrics.

In an embodiment, the protective element 10 has a surface structuring in the region of the free surfaces. The structuring firstly improves the deformability properties of the protective element 10 and secondly also has a thermal action. Simple application of the protective element 10 to a housing, for example by means of an adhesive, is additionally made possible.

In an embodiment, the protective element 10 is two-dimensional in form and is in the form of sheeting. In an embodiment, the protective element 10 can also be in the form of a shaped part. As a result of the elastic deformability of the protective element 10, the protective element 10 can in particular be stored on a reel. In an embodiment, the protective element 10 has a thickness of 1.5 mm.

The protective element 10 is produced by calendering with continuous vulcanization. Alternatively, the protective element 10 is produced by extrusion with continuous vulcanization.

In an embodiment, the protective element 10 exhibits an increase in thickness on exposure to a flame of at most 25%.

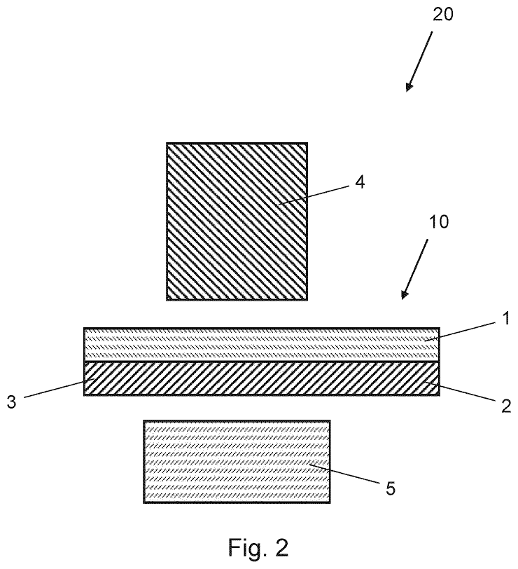

FIG. 2 shows an arrangement 20 of the protective element 10 shown in FIG. 1. The arrangement 20 comprises, besides the protective element 10, a flammable element 4 and an element 5 to be protected from flames. The protective element 10 is arranged between the flammable element 4 and the element 5 to be protected from flames. The flame-retardant layer 3 of the protective element 10 is arranged on the side facing away from the flammable element 4. The flame-retardant layer 3 of the protective element 10 is therefore arranged on the side facing the element 5 to be protected from flames. In this arrangement 20, the protective element 10 protects the element 5 to be protected in particular from penetration of flames coming from the flammable element 4. At the least, the protective element 10 provides for a substantial delay.

The arrangement 20 shown in FIG. 2 forms an energy storage system that is equipped with one or more protective elements 10. The flammable element 4 is an energy storage cell and the element 5 to be protected from flames is a housing. The protective element 10 is arranged between the storage cell and the housing, with the flame-retardant layer 3 being arranged on the side facing away from the storage cell. The protective element 10 can furthermore protect further components of the energy storage system, for instance controllers, current-conveying conduits or coolant pipes, and the like.

In the event of damage, the protective element 10 prevents excessive heat loading of the element 5 to be protected from flames, that is to say the housing. The protective element 10 is designed in this case such that it exhibits an increase in thickness under the action of heat, in particular on exposure to flame, of at most 50%. This avoids the problem of the protective element 10 blocking the venting channel in the event of damage.

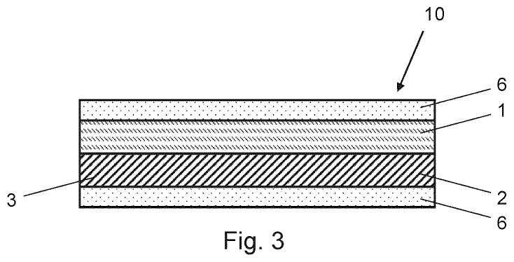

FIG. 3 shows the protective element 10 shown in FIG. 1 with a third layer 6. In an embodiment, the third layer 6 comprises a matrix, and the matrix comprises polyurethane. According to an embodiment, the matrix comprises silicone. The third layer 6 further comprises intumescent and ceramizing materials, which are embedded in the matrix. The third layer further increases the protection of the protective element 10 against thermal and mechanical loading. In an embodiment, the third layer 6 is applied to both sides of the protective element 10 as a coating of the protective element 10.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A protective element, comprising:
at least one first layer; and
at least one second layer,
wherein the first layer is made from elastomeric material and wherein the second layer forms a flame-retardant layer.

2. The protective element as claimed in claim 1, wherein the first layer comprises silicone elastomer.

3. The protective element as claimed in claim 1 wherein the first layer comprises a first filler, wherein the first filler is made from inorganic material.

4. The protective element as claimed in claim 3, wherein the first layer comprises a second filler, wherein the second filler is made from organic material.

5. The protective element as claimed in claim 4, wherein the first filler and/or the second filler contain fillers in fiber form.

6. The protective element as claimed in claim 4, wherein the first filler and/or the second filler contain fillers in particle form.

7. The protective element as claimed in claim 1, wherein the first layer contains an adhesion promoter.

8. The protective element as claimed in claim 1, wherein the flame-retardant layer comprises a textile fabric.

9. The protective element as claimed in claim 1, wherein the flame-retardant layer comprises inorganic material.

10. The protective element as claimed in claim 1, wherein the flame-retardant layer comprises organic material.

11. The protective element as claimed in claim 1, wherein the flame-retardant layer comprises metallic material.

12. The protective element as claimed in claim 1, wherein the protective element has a surface structuring.

13. The protective element as claimed in claim 1, wherein the protective element is two-dimensional in form.

14. The protective element as claimed in claim 1, wherein the protective element is in a form of a shaped part.

15. The protective element as claimed in claim 1, wherein an increase in thickness of the protective element under action of heat is less than 50%.

16. An arrangement, comprising:
the protective element as claimed in claim 1;
a flammable element; and
an element to be protected from flames,
wherein the protective element is arranged between the flammable element and the element to be protected from flames, and
wherein the flame-retardant layer of the protective element is arranged on a side facing away from the flammable element.

17. The arrangement as claimed in claim 16, wherein the element to be protected from flames is a media-conveying or a current-conveying device.

18. An energy storage system, comprising:
the protective element as claimed in claim 1; and
a housing in which at least one storage cell is arranged,
wherein the protective element is arranged between the at least one storage cell and the housing, and
wherein the flame-retardant layer is arranged on a side facing away from the storage cell.

19. The energy storage system as claimed in claim 18, further comprising a flammable element and an element to be protected from flames,
wherein the protective element is arranged between the flammable element and the element to be protected from flames, and
wherein the flame-retardant layer of the protective element is arranged on a side facing away from the flammable element.

20. The energy storage system as claimed in claim 19, wherein the element to be protected from flames is a media-conveying or a current-conveying device.
